(19) United States
(12) Patent Application Publication
(10) Pub. No.: US 2025/0267431 A1
(43) Pub. Date: Aug. 21, 2025

(54) LOCATION DEPENDENT BROADCAST SERVICE

(71) Applicant: Samsung Electronics Co., Ltd., Suwon-si (KR)

(72) Inventors: Shiyang Leng, Little Elm, TX (US); Anil Agiwal, Allen, TX (US); Kyeongin Jeong, Allen, TX (US)

(21) Appl. No.: 19/047,563

(22) Filed: Feb. 6, 2025

Related U.S. Application Data
(60) Provisional application No. 63/554,716, filed on Feb. 16, 2024.
(60) Provisional application No. 63/568,943, filed on Mar. 22, 2024.
(60) Provisional application No. 63/632,919, filed on Apr. 11, 2024.
(60) Provisional application No. 63/677,770, filed on Jul. 31, 2024.

(51) Int. Cl. H04W 4/06; H04W 4/02; H04W 4/021; H04W 76/40

(52) U.S. Cl. CPC H04W 4/06; H04W 4/021; H04W 4/023; H04W 76/40

(57) ABSTRACT

A user equipment (UE) receives broadcast service area information from the base station (BS). The broadcast service area information includes an intended area of broadcast service. The UE identifies its geographic location and/or a broadcast service area identifier based on the broadcast service area information. Then, the UE receives broadcast service from the base station based on the service area information. The broadcast service area information includes an area identifier for the intended area.

### CROSS-REFERENCE TO RELATED APPLICATIONS

This application claims the benefit of priority from U.S. Provisional Application No. 63/554,716 entitled “LOCATION-BASED CONDITIONAL EVENT FOR MOVING LOCATION,” filed Feb. 16, 2024; U.S. Provisional Application No. 63/568,943 entitled “LOCATION DEPENDENT BROADCAST SERVICE IN NON-TERRESTRIAL NETWORK,” filed Mar. 22, 2024; U.S. Provisional Application No. 63/632,919 entitled “LOCATION DEPENDENT BROADCAST SERVICE IN NON-TERRESTRIAL NETWORK,” filed Apr. 11, 2024; and U.S. Provisional Application No. 63/677,770 entitled “LOCATION DEPENDENT BROADCAST SERVICE IN NON-TERRESTRIAL NETWORK,” filed Jul. 31, 2024, all which are incorporated herein by reference in their entirety.

### TECHNICAL FIELD

This disclosure relates generally to a wireless communication system, and more particularly to, for example, but not limited to, broadcast service in a non-terrestrial network.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a user equipment (UE) for facilitating communication in a wireless network. The UE comprises a transceiver configured to receive, from a base station (BS), broadcast service area information for a broadcast service via system information. The broadcast service area information indicates an intended service area of the broadcast service. The UE comprises a processor operably coupled to the transceiver. The processor is configured to: identify a location of the UE; and receive, from the BS, the broadcast service based on the location of the UE and the intended service area.

In some embodiments, the broadcast area information includes an area identifier for the intended service area, and the processor is configured to receive the broadcast service based on the location of the UE and the area identifier for the intended service area.

In some embodiments, the intended service area is a geographic area represented by a reference location and a radius, or by a polygon.

In some embodiments, the processor is further configured to initiate a broadcast service radio bearer establishment procedure to receive the broadcast service based on a determination that the location of the UE is within the intended service area.

In some embodiments, the intended service area is associated with a broadcast service session.

In some embodiments, the processor is further configured to initiate a broadcast service radio bearer release procedure to stop receiving the broadcast service based on a determination that the UE leaves the intended service area.

In some embodiments, the processor is further configured to prioritize, during cell reselection, a frequency that is associated with receiving the broadcast service.

In some embodiments, the processor is further configured to deprioritize, during cell reselection, a frequency that is not associated with receiving the broadcast service.

An aspect of the disclosure provides a base station (BS) for facilitating communication in a wireless network. The BS comprises a processor configured to generate broadcast service area information for a broadcast service. The broadcast service area information indicates an intended service area of the broadcast service. The BS comprises a transceiver operably coupled to the processor. The transceiver is configured to transmit, to a user equipment (UE), the generated broadcast service information. The processor is further configured to generate the broadcast service associated with the broadcast service area information. The transceiver is further configured to transmit, to the UE, the generated broadcast service.

In some embodiments, the broadcast area information includes an area identifier for the intended service area.

In some embodiments, the intended service area is a geographic area represented by a reference location and a radius, or by a polygon.

In some embodiments, the intended service area is associated with a broadcast service session.

An aspect of the disclosure provides a method performed by a user equipment (UE) in a wireless network. The method comprises receiving, from a base station (BS), broadcast service area information for a broadcast service via system information. The broadcast service area information indicates an intended service area of the broadcast service. The method comprises: identifying a location of the UE; and receiving, from the BS, the broadcast service based on the location of the UE and the intended service area.

In some embodiments, the broadcast area information includes an area identifier for the intended service area, and the broadcast service is received based on the location of the UE and the area identifier for the intended service area.

In some embodiments, the intended service area is a geographic area represented by a reference location and a radius, or by a polygon.

In some embodiments, the method further comprises initiating a broadcast service radio bearer establishment procedure to receive the broadcast service based on a determination that the location of the UE is within the intended service area.

In some embodiments, the intended service area is associated with a broadcast service session.

In some embodiments, the method further comprises initiating a broadcast service radio bearer release procedure to stop receiving the broadcast service based on a determination that the UE leaves the intended service area.

In some embodiments, the method further comprises prioritizing, during cell reselection, a frequency that is associated with receiving the broadcast service.

In some embodiments, the method further comprises deprioritize, during cell reselection, a frequency that is not associated with receiving the broadcast service.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process for a location-dependent broadcast service in accordance with an embodiment.

FIG. 5 shows another example process for a location-dependent broadcast service in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

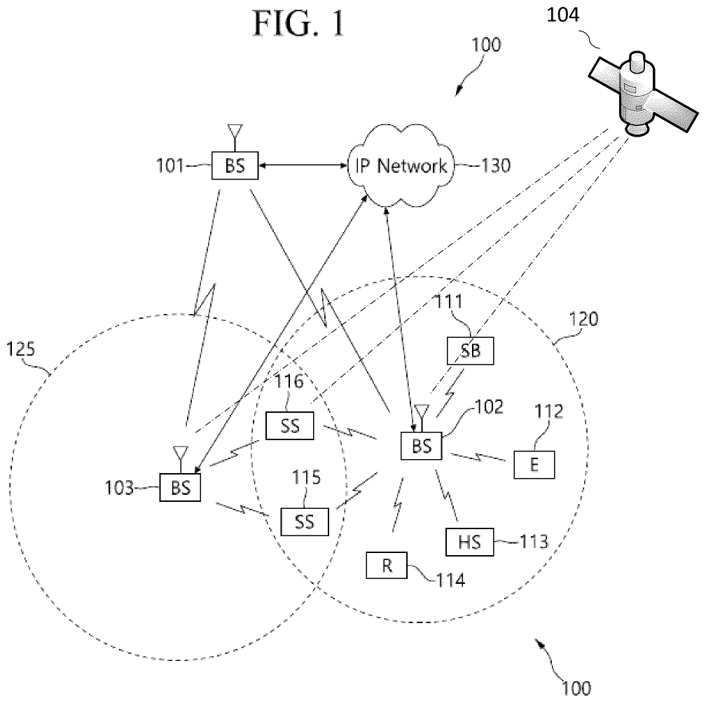

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

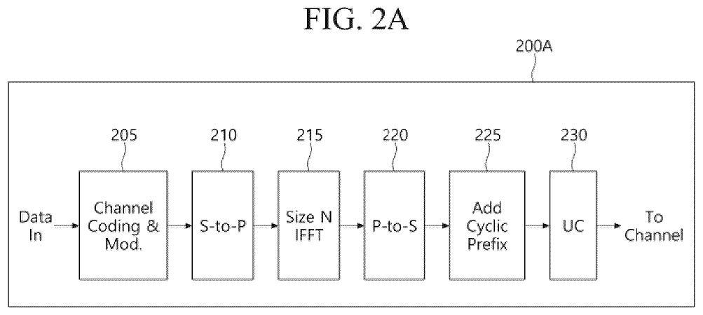

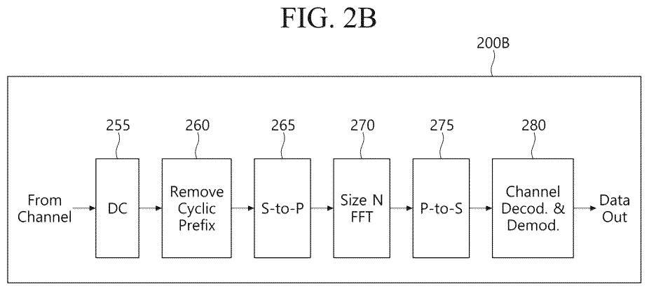

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

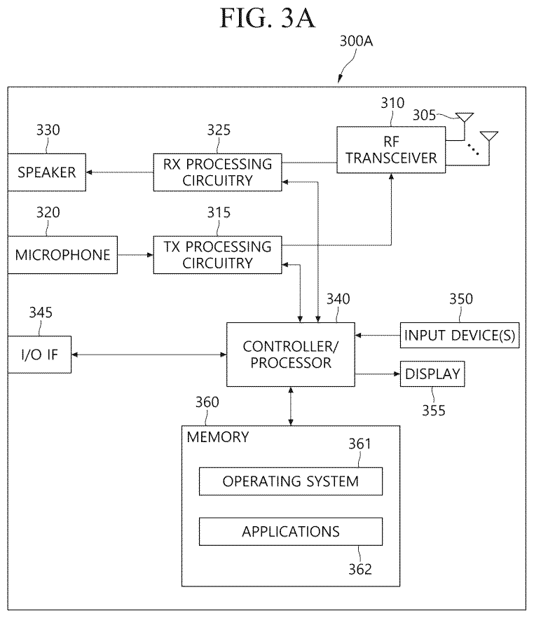

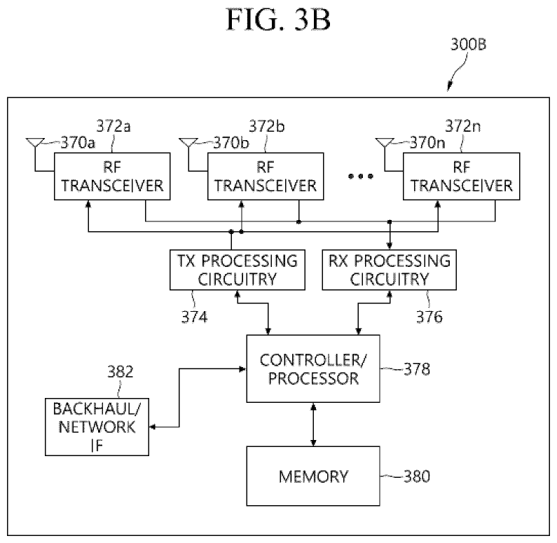

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-3702N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power) and reports the results to the BS.

The BS 300B of FIG. 3B may also include additional or different types of memory 380, including dynamic random-access memory (DRAM), non-volatile flash memory, static RAM (SRAM), different levels of cache memory. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM) may be formulated by the inventors and designed to assist in providing an efficient description of the unique features within the disclosure.

The following documents are hereby incorporated by reference in their entirety into the present disclosure as if fully set forth herein: i) 3GPP TS 38.300 v18.1.0; ii) 3GPP TS 38.331 v18.1.0; iii) 3GPP TS 38.321 v18.1.0; iv) 3GPP TS 37.355 v17.70; and v) 3GPP TS 23.032 v18.1.0.

3GPP (Third-Generation Partnership Project) has developed technical specifications and standards to define new 5G radio-access technologies, known as 5G NR (new radio). In Release 17 specifications, the non-terrestrial network (NTN) was introduced as vertical functionality by 5G NR. The NTN provides non-terrestrial NR access to UEs by means of, for example and without limitation, an NTN payload (e.g., a satellite) and an NTN Gateway. The NTN payload transparently forwards the radio protocol received from the UE via a service link (e.g., wireless link between the UE and the NTN payload) to the NTN Gateway via a feeder link (e.g., wireless link between the NTN payload and the NTN Gateway), and vice versa. Given its capabilities of providing wide coverage and reliable service, the NTN is envisioned to ensure service availability and continuity ubiquitously. For instance, the NTN can support communication services in unserved areas that are not covered by conventional terrestrial networks, as well as in underserved areas with limited communication services. Additionally, the NTN can support communication services for devices and passengers aboard moving platforms, such as railway, maritime, or aeronautical communication systems. To support the NTN in 5G NR, various features need to be introduced or enhanced to accommodate the nature of radio access to the NTN, which differs from terrestrial network (TN) in aspects, such as large cell coverage, long propagation delay, and non-static cell/satellite.

In the NTN, the NTN payload may be a geosynchronous orbit (GSO) that is an earth-centered orbit at approximately 35,786 kilometers above earth's surface and synchronized with earth's rotation. The NTN payload may be a non-geosynchronous orbit (NGSO) that is a Low Earth Orbit (LEO) at an altitude approximately between 300 km and 1,500 km or Medium Earth Orbit (MEO) at an altitude approximately between 7,000 km and 25,000 km. Depending on different NTN payloads, three types of service links can be supported. The first is an earth-fixed service link, provisioned by beams that continuously cover the same geographic areas, such as a GSO satellite. The second is a quasi-earth-fixed service link, provisioned by beams that cover one geographic area for a limited time period and another geographic area at a different time period, such as an NGSO satellite generating steerable beams. The third is an earth-moving service link, provisioned by beams whose coverage area slides over the earth's surface, such as NGSO satellite generating fixed or non-steerable beams.

A base station (BS), operating with the NGSO satellite, can provide either quasi-earth-fixed cell coverage or earth-moving cell coverage, while a BS, operating with the GSO satellite, can provide earth-fixed cell coverage. Due to distinct properties of GSO and NGSO, different types of cells can be supported in the NTN including, for example, the earth-fixed cell, the quasi-earth-fixed cell, and the earth-moving cell. For a certain type of NTN payload or cell, the UE needs to support specific features or functionalities for radio access to the NTN.

In TN, a serving cell can broadcast common data to all UEs in the cell via a broadcast service. In NTN, the satellite footprint covers a much larger area than that of a TN cell coverage. However, the intended broadcast area can be smaller than the coverage of the NTN cell, and the broadcast information can be specific to some UEs in a particular area within the NTN cell. Therefore, a location-dependent broadcast is desirable in the NTN cell.

This disclosure presents various solutions of location-dependent broadcast service in NTN. The disclosure also presents various embodiments for signaling and procedures for location-dependent broadcast service.

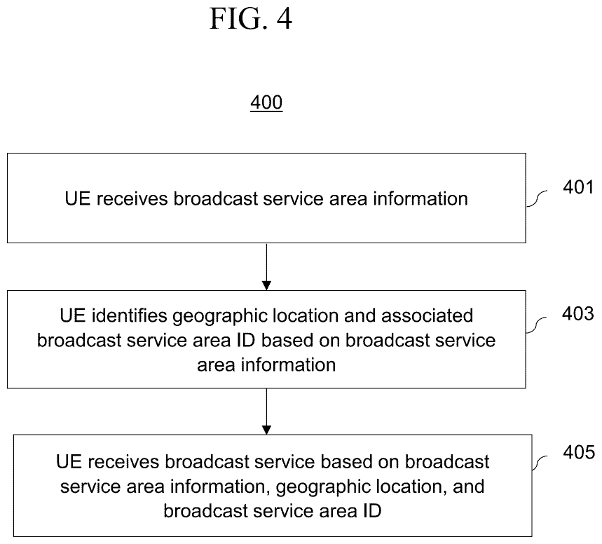

FIG. 4 shows an example process 400 for a location-dependent broadcast service in accordance with an embodiment. The location-dependent broadcast service may include services in TN and/or NTN, such as Multicast Broadcast Service (MBS), public warning service, and other broadcast services that are geographic area dependent. For explanatory and illustration purposes, the process 400 may be performed by a UE. Although one or more operations are described or shown in a particular sequential order, in other embodiments the operations may be rearranged in a different order, which may include performance of multiple operations in at least partially overlapping time periods.

In the example of FIG. 4, a UE receives broadcast service area information from the BS (e.g., gNB). Then, the UE identifies its geographic location and an associated broadcast service area identifier (ID) of an intended service area. Then, the UE receives a broadcast service from the BS based on the service area information.

Referring to FIG. 4, the process 400 may begin in operation 401. In operation 401, a UE receives broadcast service area information from a BS and applies the received broadcast service area information. The broadcast service area information may be provided in common signaling via system information or in a UE dedicated signaling via an RRC message. Examples of such RRC messages include, but are not limited to, an RRCReconfiguration message, an RRCRelease message, an RRCResume message, and an RRCReestablish message. Then, the process 400 proceeds to operation 403.

In operation 403, the UE identifies its geographic location and a broadcast service area ID of an intended service area that covers the geographical location of the UE based on the broadcast service area information. In an embodiment, when the UE supports Global Navigation Satellite System (GNSS) for high-precision positioning, it can obtain a valid GNSS location. In an embodiment, the broadcast service area information may include a list of broadcast service geographic areas (i.e., intended service areas), each identified by a broadcast service area ID (i.e., intended service area ID). Each broadcast service geographic area may be configured with a corresponding broadcast service area ID by the network. The ID can be explicitly configured or implicitly indicated by an index in the list. When the list of broadcast service geographic areas is included in the broadcast service area information, the UE may determine whether its current geographic location falls within a particular broadcast service geographic area based on its location and the list of broadcast service geographic areas. When broadcast service area IDs are configured for corresponding broadcast service geographic areas and the UE's location falls within a particular broadcast service geographic area, UE can identify a broadcast service area ID associated to the particular broadcast service geographic area. Each broadcast service geographic area may be defined and signalled by one or a combination of the following examples.

In some embodiments, each broadcast service geographic area may be configured with a broadcast service area ID and characterized by one or more circular areas, where each circular area is defined by centre coordinates (e.g., a reference location) and a radius. The centre coordinates may be signalled as a bit string, in the format of Ellipsoid-Point defined in TS37.355. The first/leftmost bit of the first octet includes the most significant bit. The radius indicates a distance from the centre coordinates, which may be signalled as an integer value in a unit of meter. For a (quasi)-earth-fixed cell, the centre coordinates (e.g., reference location) is fixed. For an earth-moving cell, the centre point may be moving. A reference location (e.g., given in the form of longitude and latitude coordinates) at a reference time may be provided. The UE may derive, estimate, or determine the movement trajectory and the real-time coordinates of the centre point based on the reference location at the given reference time and the satellite ephemeris associated with the cell which can be identified by a physical cell ID (PCI) or frequency band (e.g., Absolute Radio-Frequency Channel Number (ARFCN)). The satellite ephemeris may be provided in system information (e.g., system information block (SIB) 19 as specified in TS 38.331) for a serving cell and/or neighbour cells.

In some embodiments, each broadcast service geographic area may be configured with a broadcast service area ID and characterized by one or more polygons as defined in TS23.032. A polygon may be an arbitrary shape described by an ordered series of points. In an embodiment, the minimum number of points allowed is 3, and the maximum number of points allowed is 15. The points may be connected in the order they are given. A connecting line may be defined as the geodesic line over the ellipsoid joining the two points and with minimum distance. The last point is connected to the first point. The list of points may respect a number of conditions, including: (1) a connecting line may not cross another connecting line; (2) two successive points may not be diametrically opposed on the ellipsoid. The described area is situated to the right of the connecting lines with the downward direction being toward the earth's centre and the forward direction proceeding from a point to the next. The polygon area may be signalled in the format of Polygon defined in TS37.355.

In some embodiments, each broadcast service geographic area may be configured with a broadcast service area ID and characterized by satellite coordinates, one or multiple angles, and/or reference coordinates. The satellite coordinates may be derived based on satellite ephemeris information at an epoch time provided by the network (e.g., included in system information or UE dedicated messages). The angles may include a minimum elevation angle, a maximum elevation angle, beam bore sight angle, an angle offset to the satellite moving direction, and/or a beam angle. The reference coordinates may be signalled as a bit string, in the format of Ellipsoid-Point defined in TS37.355. The first/leftmost bit of the first octet includes the most significant bit. The radius indicates a distance from the centre coordinates, which may be signalled as an integer value in a unit of meter.

According to another embodiment, in operation 403, the UE identifies the broadcast service area ID of an intended service area that covers the UE geographic location based on its location, a predefined rule, and relevant parameters. Each geographic area may be defined as a rectangular zone. The broadcast service area ID for a geographic area may be determined based on the UE's location. In an implementation, the broadcast service area ID may be calculated by the following Equation (1).

$$ID = {y}^{′} \times Nx + {x}^{′} \qquad ( 1 )$$

where x′=ceil (x/L) mod Nx, y′=ceil (y/W) mod Ny, x and y are the longitude and latitude of the UE's location, L and W are the length and width of each zone, Nx and Ny are the number of zones in length and width. The UE may obtain its location by GNSS. L, W, Nx, and Ny may be included in broadcast service area information.

In operation 405, the broadcast service may be provided by Multicast/Broadcast Service (MBS). The UE receives the MBS in a Radio Resource Control (RRC)_IDLE state, an RRC_INACTIVE state or an RRC_CONNECTED state. The UE may receive an MBS configuration for a broadcast service session (or an MBS session) (e.g., including parameters for Multicast Traffic Channel (MTCH) reception) via Multicast Control Channel (MCCH) in the RRC_IDLE state, the RRC_INACTIVE state, or the RRC_CONNECTED state.

The parameters for MCCH reception may be provided via system information. For example, system information block 20 (SIB20) may include the necessary information to acquire the MCCH/MTCH configuration for the MBS. A UE capable of receiving the MBS (or MBS-capable UE) that is interested in receiving the MBS broadcast service via a broadcast MBS radio bearer (MRB), may have a valid version of SIB20, regardless of the RRC state. Based on the MCCH configuration in SIB20, the UE monitors a physical downlink control channel (PDCCH) addressed to a MCCH-RNTI (radio network temporary identifier) in the MCCH transmission window to receive the MCCH message. During the MCCH transmission window, the MCCH information may be repeated and the PDCCH for an MCCH message may be transmitted on at least one PDCCH monitoring occasion.

PDCCH monitoring occasion(s) for MCCH transmission may be determined according to the common search space (CSS) indicated by a ‘searchspaceMCCH’ field. When the ‘searchspaceMCCH’ field is set to zero, PDCCH monitoring occasion(s) for the MCCH message in the MCCH transmission window may be the same as PDCCH monitoring occasion(s) for SIB 1. Conversely, when the ‘searchspaceMCCH’ field is not set to zero, PDCCH monitoring occasion(s) for the MCCH message may be determined based on search space indicated by the ‘searchspaceMCCH’ field. PDCCH monitoring occasion(s) for the MCCH message that do not overlap with UL symbols (determined according to ‘tdd-UL-DL-ConfigurationCommon’ parameter) are sequentially numbered starting from one in the MCCH transmission window.

The MCCH provides a list of all broadcast services with ongoing sessions transmitted on MTCH(s) and associated information for broadcast sessions. The associated information for broadcast sessions may include an MBS session ID, associated group-common RNTI (G-RNTI) scheduling information, and information about neighboring cells providing broadcast services on the MTCH(s). The MCCH contents may be transmitted within periodically occurring time domain windows, referred to as the MCCH transmission window. The MCCH transmission window may be defined by an MCCH repetition period, an MCCH window duration, and a radio frame/slot offset.

The MCCH may use a modification period, and the MCCH contents may be only allowed to be modified at the boundaries of the modification period. A notification mechanism may be employed to announce changes to the MCCH contents, such as the start, modification, or cessation (or stop) of a broadcast session, as well as updates to neighboring cell information. When the UE receives an MCCH change notification, the UE acquires the updated MCCH within the same MCCH modification period in which the change notification is sent. In an implementation, the MCCH change notification may be represented as a 2-bit bitmap in downlink control information (DCI).

In some embodiments, the BS (e.g., gNB) delivers a single copy of MBS data packets to a set of UEs. In an embodiment, the BS uses a group-common PDCCH with a cyclic redundancy check (CRC) scrambled by a G-RNTI to schedule a group-common PDSCH, which is also scrambled with the same G-RNTI.

In some embodiments, for a location-dependent MBS, a mapping may be defined between broadcast service area IDs and monitoring occasions of PDCCH addressed to MCCH-RNTI. For an MBS-capable UE interested in receiving or currently receiving MBS in an RRC_IDLE state, an RRC_INACTIVE state, or an RRC_CONNECTED state, the UE monitors PDCCH addressed to MCCH-RNTI for the MCCH message within the MCCH transmission window. UE may only monitor occasions corresponding to its identified broadcast service area ID. The UE receives the broadcast services configured in the received MCCH message.

In some embodiments, a mapping between broadcast service area IDs and MCCH search space IDs may be included in the broadcast service area information. Specific MCCH search space IDs are configured to transmit MCCH messages associated with a broadcast service area ID. To receive the corresponding MCCH message within the MCCH transmission window, the UE monitors PDCCH occasions determined based on the MCCH search space IDs mapped to the UE's identified broadcast service area ID. The UE assumes that, within the MCCH transmission window, a PDCCH for an MCCH message is transmitted in at least one PDCCH monitoring occasion determined based on the MCCH search space IDs mapped to its identified broadcast service area ID.

In some embodiments, a mapping between a broadcast service area ID and a subset of synchronization signal/physical broadcast channel blocks (SSBs) may be included in the broadcast service area information. A subset of SSBs, indicated by SSB indexes, are used to transmit the MCCH message associated with a broadcast service area ID. To receive the MCCH message in MCCH transmission window, the UE monitors PDCCH occasions that correspond to the SSBs associated with its identified broadcast service area ID. The UE assumes that, in the MCCH transmission window, the PDCCH for an MCCH message is transmitted in at least one PDCCH monitoring occasion corresponding to each SSB associated with its identified broadcast service area ID. The selection of SSB for receiving MCCH messages may be determined by the UE implementation.

In some embodiments, for a location-dependent MBS, the broadcast service area information may include a mapping between broadcast service area IDs and at least one of the followings: i) Temporary Mobile Group Identities (TMGIs); ii) MBS IDs; iii) MBS session IDs; iv) G-RNTIs; v) Logical Channel IDs for MBS; vi) MRB IDs for MBS; vii) PLMN IDs; viii) tracking area codes (TACs); ix) PCIs; x) SSB indexes; or xi) MTCH search space IDs.

In some embodiments, for an MBS-capable UE interested in receiving or currently receiving MBS in an RRC_IDLE state, an RRC_INACTIVE state, or an RRC_CONNECTED state, the followings may apply: if the UE identifies a broadcast service area ID of an intended service area that covers its geographic location, and the broadcast service area ID is mapped, configured, or associated with one or more TMGIs, MBS session IDs, MBS service IDs, or G-RNTIs, the UE may initiate a broadcast MRB establishment procedure to begin receiving the MBS session(s) that the UE is interested in and that is associated with corresponding TMGIs, MBS session IDs, MBS service IDs, or G-RNTIs mapped to the broadcast service area ID. The UE receives the MBS session associated with the TMGI, MBS session ID, MBS service ID, or G-RNTI mapped to the broadcast service area ID. To receive the corresponding MBS session in the MTCH, the UE monitors PDCCH addressed to the G-RNTI assigned to the MBS session in a MTCH-SSB mapping window according to the configuration of MTCH-SSB mapping window for the corresponding MBS session. The UE receives then the PDSCH scheduled by the DCI on the monitored PDCCH occasion.

In some embodiments, for an MBS-capable UE interested in receiving or currently receiving MBS in an RRC_IDLE state, an RRC_INACTIVE state, or an RRC_CONNECTED state, the following may apply: if the UE identifies that it is leaving the geographic location associated with a broadcast service area ID, and the broadcast service area ID is mapped, configured, or associated with one or more TMGIs, MBS session IDs, MBS service IDs, or G-RNTIs (or, Logical Channel IDs, MRB IDs, SSB indexes, PLMN IDs, TACs, PCIs, or MTCH search space IDs) of the current MBS, the UE may initiate a broadcast MRB release procedure to stop receiving the MBS session(s) associated with the TMGIs, MBS session IDs, MBS service IDs, or G-RNTIs that are mapped to the broadcast service area ID. The UE may stop monitoring PDCCH addressed to the G-RNTI assigned to the MBS session in the MTCH-SSB mapping window. The G-RNTI is assigned according to the configuration of MTCH-SSB mapping window for the corresponding MBS session.

In some embodiments, for an MBS-capable UE interested in receiving or currently receiving MBS in an RRC_IDLE state, an RRC_INACTIVE state, or an RRC_CONNECTED state, the following may apply: if the UE identifies a broadcast service area ID for its geographic location, and the broadcast service area ID is mapped, configured, or associated with one or more Logical Channel IDs (and/or MRB IDs), the UE may initiate a broadcast MRB establishment procedure to start receiving the MBS session(s) that UE is interested in and associated with the Logical Channel IDs (and/or MRB IDs) mapped to the broadcast service area ID. The UE receives the MBS broadcast session(s) associated with each Logical Channel ID (and/or MRB ID) mapped to the broadcast service area ID. To receive the corresponding MBS broadcast session in the MTCH, the UE monitors PDCCH addressed to the G-RNTI assigned for to the MBS session in a MTCH-SSB mapping window. The G-RNTI is assigned according to the configuration of MTCH-SSB mapping window for the corresponding MBS broadcast session. The UE receives the PDSCH scheduled by the DCI on each monitored PDCCH occasion.

In some embodiments, for an MBS-capable UE interested in receiving or currently receiving MBS in an RRC_IDLE state, an RRC_INACTIVE state, or an RRC_CONNECTED state, the following may apply: if the UE identifies a broadcast service area ID of an intended service area that covers its geographic location, and the broadcast service area ID is mapped, configured, or associated with one or more SSB indexes, The UE receives the MBS session(s) associated with each SSB mapped to the broadcast service area ID. To receive the corresponding MBS session in the MTCH, the UE monitors PDCCH addressed to the G-RNTI assigned for to the MBS session in a MTCH-SSB mapping window according to the configuration of MTCH-SSB mapping window for the corresponding MBS broadcast session. In the MTCH-SSB mapping window, the UE monitors the PDCCH occasions that are transmitted on the SSBs mapped to the broadcast service area ID. The UE then receives the PDSCH scheduled by the DCI on each monitored PDCCH occasion.

In some embodiments, for an MBS-capable UE interested in receiving or currently receiving MBS in an RRC_IDLE state, an RRC_INACTIVE state, or an RRC_CONNECTED state, the following may apply: if the UE identifies a broadcast service area ID for its geographic location, and the broadcast service area ID is mapped, configured, associated with one or more PLMN (public land mobile network) IDs (or, TACs or PCIs), the UE initiates a broadcast MRB establishment procedure to start receiving the MBS session that UE is interested in and associated with each PLMN ID (or, TAC or PCI) mapped to the broadcast service area ID. The UE receives the MBS session associated with each PLMN ID (and/or TAC and/or PCI) mapped to the broadcast service area ID. To receive the corresponding MBS session in the MTCH, UE monitors PDCCH addressed to the G-RNTI assigned to the MBS broadcast session in a MTCH-SSB mapping window according to the configuration of MTCH-SSB mapping window for the corresponding MBS broadcast session. The UE then receives the PDSCH scheduled by the DCI on each monitored PDCCH occasion.

In some embodiments, for an MBS-capable UE interested in receiving or currently receiving the MBS in an RRC_IDLE state, an RRC_INACTIVE state, or an RRC_CONNECTED state, if the UE identifies a broadcast service area ID for its geographic location, and the broadcast service area ID is mapped, configured, or associated with one or more MTCH search space IDs, the UE receives the MBS session(s) associated with each MTCH search space ID mapped to the broadcast service area ID. To receive the corresponding MBS session in the MTCH, the UE monitors PDCCH addressed to the G-RNTI assigned for to the MBS session, in a MTCH-SSB mapping window according to the configuration of MTCH-SSB mapping window for the corresponding MBS broadcast session. The PDCCH monitoring occasions in the MTCH-SSB mapping window is determined by the MTCH search space ID mapped to the broadcast service area ID. In the MTCH-SSB mapping window, the UE monitors the PDCCH occasions determined by the MTCH search space ID mapped to the broadcast service area ID and receives the PDSCH scheduled by the DCI on each monitored PDCCH occasion.

In some embodiments, the broadcast service area information may be provided in SIB for neighbor cells, frequencies, and/or an MBS Frequency Selection Area Identities (FSAIs) for cell reselection. For instance, in the list of neighbor cells in a SIB, one or more service area IDs (i.e., intended service area IDs) may be configured or associated with each neighbor cell's PCI or frequency (e.g., ARFCN value) to indicate that the MBS associated with that service area ID(s) is provided in the neighbor cell or on the frequency. If an MBS-capable UE identifies a broadcast service area ID of an intended service area that covers its geographic location and the service area ID is associated with a neighbor cell or a frequency, the UE may prioritize the neighbor cell or the frequency in cell reselection.

In some embodiments, in the list of MBS FSAIs in a SIB, one or more service area IDs may be configured or associated with each MBS FSAI, which indicates that an MBS associated with service area ID(s) is provided for the MBS FSAI. If an MBS-capable UE identifies a broadcast service area ID for its geographic location and the service area ID is associated with a MBS FSAI, the UE then may prioritize the frequency (e.g., ARFCN value) associated with the MBS FSAI in cell reselection.

In some embodiments, if an MBS-capable UE identifies a broadcast service area ID for its geographic location and is interested in receiving or currently receiving an MBS associated with the broadcast service area ID, and if the UE can only receive the MBS by camping on a specific frequency, the UE may consider the frequency to have the highest priority during the MBS session as long as the two following conditions are fulfilled:
1) SIB1 scheduling information of the cell reselected by the UE due to frequency prioritization for MBS includes SIB20; and
2) i) one or more MBS FSAI(s) of that frequency is indicated in SIB21 of the serving cell and the same MBS FSAI(s) is also indicated for this MBS in MBS User Service Description (USD), ii) SIB21 is not provided in the serving cell and that frequency is included in the USD of this service, or iii) SIB21 is provided in the serving cell but does not provide the frequency mapping for the concerned service and the frequency is included in the USD of this service.

In some embodiments, if an MBS-capable UE identifies a broadcast service area ID of an intended service area that covers its geographic location and is interested in receiving or currently receiving an MBS associated with the broadcast service area ID, the UE may consider cell reselection candidate frequencies where the MBS is not received to have the lowest priority during the MBS broadcast session, as long as SIB1 scheduling information of the cell includes SIB20 on the MBS frequency which the UE monitors and as long as the condition 2) above is fulfilled for the serving cell.

In some embodiments, for MBS in NTN, the timer for reassembly in a radio link control (RLC) layer associated with an MBS broadcast session is extended. As an example, the extended values can be {ms210, ms220, ms340, ms350, ms550, ms1100, ms1650, ms2200}, where ms210 means 210 milliseconds, ms220 means 220 milliseconds and so on. The extended value can be configured in MRB-RLC-ConfigBroadcast, which is included in the IE MBS-SessionInfoList in MBSBroadcastConfiguration message. The NW configures and/or UE applies the extended value for MBS broadcast service in NTN.

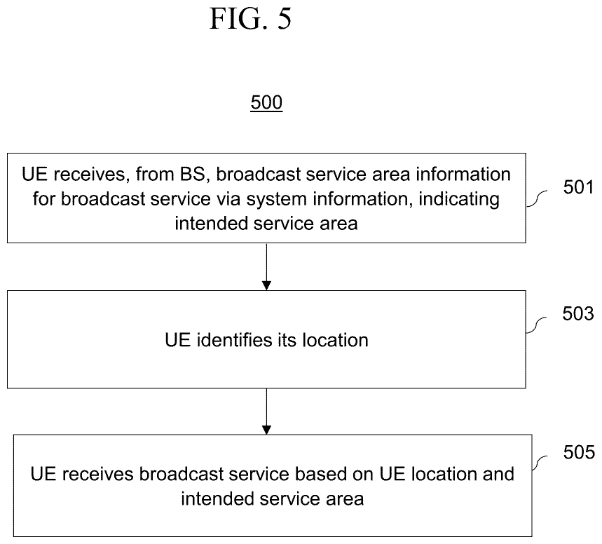

FIG. 5 shows an example process 500 for a location-dependent broadcast service in accordance with an embodiment. The location-dependent broadcast service may include services in TN and/or NTN, such as MBS, public warning service, and other broadcast services that are geographic area dependent. For explanatory and illustration purposes, the process 500 may be performed by a UE. Although one or more operations are described or shown in a particular sequential order, in other embodiments the operations may be rearranged in a different order, which may include performance of multiple operations in at least partially overlapping time periods.

Referring to FIG. 5, the process 500 may begin in operation 501. In operation 501, a UE receives, from a BS, broadcast service area information for broadcast service from via system information. The broadcast service area information indicates an intended service area of the broadcast service. In an embodiment, the broadcast area information includes an area identifier for the intended service area. In an embodiment, the intended service area is a geographic area represented by a reference location and a radius, or by a polygon. Then, the process 500 proceeds to operation 503.

In operation 503, the UE identifies a location of the UE. Then, the process 500 proceeds to operation 505.

In operation 505, the UE receives the broadcast service based on the location of the UE and the intended service area of the broadcast service. In an embodiment, the UE receives the broadcast service based on the location of the UE and the area identifier for the intended service area.

In some embodiments, the UE initiates a broadcast service radio bearer establishment procedure to receive the broadcast service based on a determination that the location of the UE is within the intended service area.

In some embodiments, the intended service area is associated with a broadcast service session.

In some embodiments, the UE initiates a broadcast service radio bearer release procedure to stop receiving the broadcast service based on a determination that the UE leaves the intended service area.

In some embodiments, the UE prioritizes, during cell reselection, a frequency that is associated with receiving the broadcast service.

In some embodiments, the UE deprioritizes, during cell reselection, a frequency that is not associated with receiving the broadcast service.

In Release-18 NTN enhancement, a conditional handover (CHO) is enhanced to be applied for earth-moving cells. A location-based conditional event with moving location(s) is introduced, for example and without limitation, condEventD2 with referenceLocation1, referenceLocation2, distanceThreshFromReference1, and distanceThreshFromReference2. The UE evaluates the distance to a location of a serving cell and the distance to a location of a CHO candidate cell. If the distance to the location of the service call is above a threshold and the distance to the location of the CHO candidate cell is below a threshold, the conditional event is triggered.

When there are two cells involved in the location-based conditional event evaluation, it is possible that either the serving cell or the candidate cell is an earth moving cell, or both are earth moving cells. Considering all these possible scenarios, condEventD2 may be configured and applied when at least one cell is an earth moving cell.

For an earth-moving cell, the UE determines a real-time reference location based on the given reference location at an epoch time and satellite ephemeris. One issue is how to determine an earth-moving cell so that the UE estimates the real-time reference location for the cell. The other issue is how to provide the epoch time for the reference location of the earth moving cell.

This disclosure provides various embodiments to signal necessary parameters and specify a UE behavior to determine moving reference location for location-based conditional event. The embodiments presented in the disclosure are applicable to scenarios involving NTN earth moving cell and other scenarios with moving locations, coordinates, or positions. These moving locations, coordinates, or positions can be estimated, predicted, determined, or derived based on assistance information.

In some embodiments, in condEventD2, epochTime1 and epochTime2 for referenceLocation1 and referenceLocation2 are signaled, respectively. The presence of the epoch time parameter indicates that the associated reference location is for an earth-moving cell. If the reference location is for a (quasi)-fixed cell, the epoch time parameter is absent. If the serving cell is an earth-moving cell, the UE determines the real-time reference location based on the referenceLocation1 at the epochTime1 in condEventD2 and the serving cell ephemeris in SIB19. If the candidate cell is an earth moving cell, the UE determines the real-time reference location based on the referenceLocation2 at the epochTime2 in condEventD2, the candidate cell's ephemeris, and the associated epoch time provided in the measurement object configuration or in the neighbor cell configuration in SIB19 or in the condEventD2.

In some embodiments, the condEventD2 is triggered when a distance between UE and reference location of a serving cell is above threshold1 and a distance between UE and reference location of a candidate cell is below threshold2, and at least one reference location is moving. In an embodiment, the UE may perform the following operations:
1> if epochTime1 is present in reportConfigNR for this event:
   2> consider the reference location of the serving cell is moving;
   2> determine the reference location for variable Ml1 and Thresh1, as specified below, based on referenceLocation1 at the epochTime1 as defined within reportConfigNR for this event and the serving cell's satellite ephemeris.
1> else:
   2> set the reference location for variable Ml1 and Thresh1, as specified below, as referenceLocation1 in reportConfigNR for this event.
1> if epochTime2 is present in reportConfigNR for this event:
   2> consider the reference location of the candidate is moving;
   2> determine the reference location for variable Ml2 and Thresh2, as specified below, based on referenceLocation2 at the epochTime2 as defined within reportConfigNR for this event and the candidate's satellite ephemeris (e.g., the candidate's satellite ephemeris can be included in this event i.e., condEventD2, or in the measurement object configuration configured for this event, or in the SIB19 provided by neighbor cell configuration).
1> else:
   2> set the reference location for variable Ml2 and Thresh2, as specified below, as referenceLocation2 in reportConfigNR for this event.
1> consider the entering condition for this event to be satisfied when both condition D2-1 and condition D2-2, as specified below, are fulfilled;
1> consider the leaving condition for this event to be satisfied when condition D2-3 or condition D2-4, i.e. at least one of the two, as specified below, are fulfilled;

### Inequality D2-1 (Entering Condition 1)

$$Ml 1 - Hys > Thresh 1 \qquad ( 2 )$$

### Inequality D2-2 (Entering Condition 2)

$$Ml 2 + Hys < Thresh 2 \qquad ( 3 )$$

### Inequality D2-3 (Leaving Condition 1)

$$Ml 1 + Hys < Thresh 1 \qquad ( 4 )$$

### Inequality D2-4 (Leaving Condition 2)

$$Ml 2 - Hys > Thresh 2 \qquad ( 5 )$$

The variables in the formula are defined as follows:
Ml1 is the distance between UE and a reference location for this event, not taking into account any offsets.
Ml2 is the distance between UE and a reference location for this event, not taking into account any offsets.
Hys is the hysteresis parameter for this event (i.e. hysteresisLocation as defined within reportConfigNR for this event).
Thresh1 is the threshold for this event defined as a distance, configured with parameter distance ThreshFromReference1, from a reference location.
Thresh2 is the threshold for this event defined as a distance, configured with parameter distance ThreshFromReference2, from a reference location.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

In some embodiments, the epoch time in SIB19 may be specified as follows. The epochTime indicates the epoch time for NTN assistance information. When explicitly provided through SIB, or through dedicated signaling, the EpochTime is the starting time of a downlink (DL) sub-frame, indicated by a system frame number (SFN) and a sub-frame number signaled together with the assistance information. For a serving cell, the field sfn indicates the current SFN or the next upcoming SFN after the frame where the message indicating the epochTime is received. For a neighbor cell, the sfn indicates the SFN nearest to the frame where the message indicating the epochTime is received. The reference point for epoch time of the serving or neighbour NTN payload ephemeris and Common TA (timing advance) parameters is the uplink time synchronization reference point when this field is provided in an NTN cell, and the gNB when this field is provided in a TN cell. If this field is absent for the serving cell, the epoch time is the end of system information (SI) window where this SIB19 is scheduled. This field is mandatory present when ntn-Config is provided in a dedicated configuration. If this field is absent in ntn-Config provided via NTN-NeighCellConfig, the UE uses the epoch time of the serving cell. Otherwise, the field is based on the timing of the serving cell. For example, the SFN and sub-frame number indicated in this field refers to the SFN and sub-frame of the serving cell. When included in ServingCellConfigCommon for a handover or a conditional handover, this field is based on the timing of the target cell, for example, the SFN and sub-frame number indicated in this field refers to the SFN and sub-frame of the target cell. For the target cell, the UE considers the epoch time, indicated by the SFN and sub-frame number in this field, to be the frame nearest to the frame in which the message indicating the epoch time is received. This field is excluded when determining changes in system information. In other workds, changes to epochTime neither results in system information change notifications nor cause a modification of value Tag in SIB1.

In some embodiments, the RRC signaling to configure condEventD2 can be specified as follows. The IE ReportConfigNR specifies criteria for triggering of an NR measurement reporting event or of a CHO, CPA (conditional PSCell addition) or CPC (conditional PSCell change) event or of an layer 2 (L2) UE-to-Network (U2N) relay measurement reporting event. For events labelled AN with N equal to 1, 2 and so on, measurement reporting events and CHO, CPA or CPC events are based on cell measurement results, which can either be derived based on SS/PBCH block or CSI-RS (channel state information reference signal). In an embodiment, the CondEventD2 is triggered when i) a distance between UE and a reference location of a serving cell becomes larger than configured threshold distance ThreshFromReference1 and ii) a distance between UE and a reference location of conditional reconfiguration candidate becomes shorter than configured threshold distance ThreshFromReference2, and at least one reference location is moving. An example of ReportConfigNR information element is provided in the Tables 1 and 2.

TABLE 1

| ReportConfigNR ::= | SEQUENCE { | |
|---|---|---|
| reportType | CHOICE { | |
| periodical | PeriodicalReportConfig, | |
| eventTriggered | EventTriggerConfig, | |
| ... | | |
| } | | |
| } | | |
| CondTriggerConfig-r16 ::= | SEQUENCE { | |
| condEventId | CHOICE { | |
| condEventA3 | SEQUENCE { | |
| a3-Offset | MeasTriggerQuantityOffset, | |
| hysteresis | Hysteresis, | |
| timeToTrigger | TimeToTrigger | |
| }, | | |
| condEventA5 | SEQUENCE { | |
| a5-Threshold1 | MeasTriggerQuantity, | |
| a5-Threshold2 | MeasTriggerQuantity, | |
| hysteresis | Hysteresis, | |
| timeToTrigger | TimeToTrigger | |
| }, | | |
| condEventA4-r17 | SEQUENCE { | |
| a4-Threshold-r17 | MeasTriggerQuantity, | |
| hysteresis-r17 | Hysteresis, | |
| timeToTrigger-r17 | TimeToTrigger | |
| }, | | |
| condEventD1-r17 | SEQUENCE { | |
| distanceThreshFromReference1-r17 INTEGER(0.. 65525), | | |
| distanceThreshFromReference2-r17 INTEGER(0.. 65525), | | |
| referenceLocation1-r17 | ReferenceLocation-r17, | |
| referenceLocation2-r17 | ReferenceLocation-r17, | |
| hysteresisLocation-r17 | HysteresisLocation-r17, | |
| timeToTrigger-r17 | TimeToTrigger | |
| }, | | |
| condEventT1-r17 | SEQUENCE { | |
| t1-Threshold-r17 | INTEGER (0..549755813887), | |
| duration-r17 | INTEGER (1..6000) | |
| }, | | |
| condEventD2-r18 | SEQUENCE { | |
| distanceThreshFromReference1-r18 INTEGER(0.. 65525), | | |
| distanceThreshFromReference2-r18 INTEGER(0.. 65525), | | |
| referenceLocation1-r18 | ReferenceLocation-r17, | |
| referenceLocation2-r18 | ReferenceLocation-r17, | |
| hysteresisLocation-r18 | HysteresisLocation-r17, | |
| timeToTrigger-r18 | TimeToTrigger, | |
| epochTime1-r18 | EpochTime-r17 | OPTIONAL, -- Need R |
| epochTime2-r18 | EpochTime-r17 | OPTIONAL, -- Need R |
| } | | |
| }, | | |
| } | | |

TABLE 2
CondTriggerConfig field descriptions

a3-Offset
Offset value(s) to be used in NR conditional reconfiguration triggering condition for cond
event a3. The actual value is field value * 0.5 dB.
a4-Threshold
Threshold value associated to the selected trigger quantity (e.g. RSRP, RSRQ, SINR) per RS
Type (e.g. SS/PBCH block, CSI-RS) to be used in NR conditional reconfiguration triggering
condition for cond event a4.
a5-Threshold1/a5-Threshold2
Threshold value associated to the selected trigger quantity (e.g. RSRP, RSRQ, SINR) per RS
Type (e.g. SS/PBCH block, CSI-RS) to be used in NR conditional reconfiguration triggering
condition for cond event a5. In the same condeventA5, the network configures the same
quantity for the MeasTriggerQuantity of the a5-Threshold1 and for the MeasTriggerQuantity
of the a5-Threshold2.
condEventId
Choice of NR conditional reconfiguration event triggered criteria.
distanceThreshFromReference1, distanceThreshFromReference2
Distance from a fixed reference location configured with referenceLocation1 or
referenceLocation2 or a moving reference location determined by the UE based on
referenceLocation1 or referenceLocation2. Each step represents 50 m.
duration
This field is used for defining the leaving condition T1-2 for conditional HO event
condEventT1. Each step represents 100 ms.
epochTime1, epochTime2
Indicates the time reference of referenceLocation1 and referenceLocation2, respectively. This
field is based on the timing of the serving cell, i.e. the SFN and sub-frame number indicated in
this field refers to the SFN and sub-frame of the serving cell.
nesEvent
Indicates the event is a NES-specific CHO event and the event is only considered to be
satisfied if indication from lower layers is received indicating the applicability of NES-specific
CHO event and the related entry condition(s) is fulfilled. This field can only be configured for
condEventA3, condEventA4 or condEventA5.
referenceLocation1, referenceLocation2
Reference locations used for condEventD1 and condEventD2. The referenceLocation1 is
associated to serving cell and referenceLocation2 is associated to candidate target cell.
t1-Threshold
The field counts the number of UTC seconds in 10 ms units since 00:00:00 on Gregorian
calendar date 1 Jan., 1900 (midnight between Sunday, Dec. 31, 1899 and Monday,
Jan. 1, 1900).
timeToTrigger
Time during which specific criteria for the event needs to be met in order to execute the
conditional reconfiguration evaluation.

In some embodiments, the existing parameters in SIB19, condEventD2, and/or measurement object configuration may be reused, and referenceLocation1 in condEventD2 optional may be optional.

If movingReferenceLocation is present in SIB19 for this event, or if referenceLocation1 in reportConfigNR for this event is absent, the serving cell is an earth-moving cell. Otherwise, for example, if movingReferenceLocation is absent in SIB19, or if referenceLocation1 in reportConfigNR for this event is present, the serving cell is a (quasi)-fixed cell.

The presence of epoch time in measurement object configuration of condEventD2 may indicate that the candidate cell is an earth moving cell. If the candidate cell is a (quasi)-fixed cell, the epoch time in measurement object configuration is absent. If the epoch time is present, the ephemeris of the candidate cell in measurement object configuration can be present and the epoch time is also associated with the ephemeris of the candidate cell. If the epoch time is present and the ephemeris in measurement object configuration is absent, the ephemeris in the SIB19 neighbor cell configuration is applied.

In some embodiments, an epoch time of the candidate's reference location and/or candidate's ephemeris may be included in condEventD2. The presence of the epoch time in condEventD2 indicates that the candidate cell is an earth moving cell. If the candidate cell is a (quasi)-fixed cell, the epoch time in condEventD2 is absent. If the epoch time is present, the ephemeris of the candidate cell in condEventD2 may be present and the epoch time is also associated with the ephemeris of the candidate cell. If the epoch time is present and the ephemeris in condEventD2 is absent, the ephemeris in the SIB19 neighbor cell configuration is applied.

If the serving cell is an earth-moving cell while the candidate cell is a (quasi)-fixed cell, the UE determines the real-time reference location of the serving cell based on the serving cell's movingReferenceLocation, ephemeris, and an associated epoch time in SIB19. In an embodiment, the referenceLocation1 in condEventD2 is absent, and referenceLocation1 in condEventD2 is optional present, for example, with need code R.

If the candidate cell is an earth moving cell while the serving cell is a (quasi)-fixed cell, the UE determines the real-time reference location of the candidate based on the referenceLocation2 in condEventD2 at the epochTime in condEventD2 (or in the corresponding measurement object configuration), the candidate cell's ephemeris and the associated epoch time. As the epoch time is present, the ephemeris of the candidate cell in condEventD2 (or in measurement object configuration) may be present, and the epoch time is also associated with the ephemeris of the candidate cell. If the ephemeris in condEventD2 (or in measurement object configuration) is absent, the ephemeris in the SIB19 neighbor cell configuration is applied.

If both the serving cell and the candidate cell are earth-moving cells, referenceLocation1 for the serving cell in condEventD2 may be present. In this case, the epoch time in condEventD2 or in the measurement object configuration is also associated with condEventD2, indicating that the referenceLocation1 is at the epoch time in condEventD2 or in the measurement object configuration. If referenceLocation1 is absent, the serving cell's movingReferenceLocation, ephemeris and the associated epoch time in SIB19 are applied.

In some embodiments, the condEventD2 may be specified as follows. The condEvent D2 may triggered when a distance between UE and a reference location of a serving cell is above threshold1 and a distance between UE and a reference location of a candidate is below threshold2, at least one reference location is moving. The UE may perform the following operations:
1> if movingReferenceLocation is present in SIB19 (and/or if referenceLocation1 in reportConfigNR for this event is absent):
   2> consider the reference location of the serving cell is moving;
   2> determine the reference location for variable Ml1 and Thresh1, as specified below, based on movingReferenceLocation and the serving cell's satellite ephemeris.
1> else (i.e., if movingReferenceLocation is absent in SIB19 and/or if referenceLocation1 in reportConfigNR for this event is present):
1>2> set the reference location for variable Ml1 and Thresh1, as specified below, as referenceLocation1 in reportConfigNR for this event.
1> if epochTime is present in measObjectNR (or reportConfigNR) for this event:
   2> consider the reference location of the candidate is moving;
   2> determine the reference location for variable Ml2 and Thresh2, as specified below, based on referenceLocation2 at the epochTime as defined within measObjectNR (or reportConfigNR) for this event and the candidate's satellite ephemeris (e.g., the candidate's satellite ephemeris can be included in this event i.e., condEventD2, or in the measurement object configuration configured for this event, or in the SIB19 provided by neighbor cell configuration).
1> else:
   2> set the reference location for variable Ml2 and Thresh2, as specified below, as reference Location2 in reportConfigNR for this event.
1> consider the entering condition for this event to be satisfied when both condition D2-1 and condition D2-2, as specified below, are fulfilled;
1> consider the leaving condition for this event to be satisfied when condition D2-3 or condition D2-4, i.e. at least one of the two, as specified below, are fulfilled;

### Inequality D2-1 (Entering Condition 1)

$$Ml 1 - Hys > Thresh 1 \qquad ( 6 )$$

### Inequality D2-2 (Entering Condition 2)

$$Ml 2 + Hys < Thresh 2 \qquad ( 7 )$$

### Inequality D2-3 (Leaving Condition 1)

$$Ml 1 + Hys < Thresh 1 \qquad ( 8 )$$

### Inequality D2-4 (Leaving Condition 2)

$$Ml 2 - Hys > Thresh 2 \qquad ( 9 )$$

The variables in the formula are defined as follows:
Ml1 is the distance between UE and a reference location for this event, not taking into account any offsets.
Ml2 is the distance between UE and a reference location for this event, not taking into account any offsets.
Hys is the hysteresis parameter for this event (i.e. hysteresisLocation as defined within reportConfigNR for this event).
Thresh1 is the threshold for this event defined as a distance, configured with parameter distance ThreshFromReference1, from a reference location.
Thresh2 is the threshold for this event defined as a distance, configured with parameter distance ThreshFromReference2, from a reference location.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

In some embodiments, movingReferenceLocation indicates a reference location of the serving cell of an NTN Earth moving system at a time reference. It may be used in location-based measurement initiation in an RRC_IDLE state and/or an RRC_INACTIVE state, and a location-based conditional event for CHO. The time reference of this field is indicated by epochTime in ntn-Config of the serving cell. This field is excluded when determining changes in system information. For example, changes to movingReferenceLocation may neither result in system information change notifications nor cause modification of value Tag in SIB1. This field is only present in an NTN cell.

In some embodiments, the condEventD2 may be applied only when both the serving cell and the candidate cell are earth moving cell. The epoch time is mandatory present in condEventD2 or in the measurement object configuration associated with the condEventD2. The epoch time indicates the time reference for both referenceLocation1 and referenceLocation2 in condEventD2. The UE determines the real-time reference location of the serving cell based on the serving cell's referenceLocation1 at the epoch time (in condEventD2), serving cell's ephemeris and the associated epoch time in SIB19. The UE determines the real-time reference location of the candidate based on the referenceLocation2 at the epochTime (in condEventD2), the candidate cell's ephemeris and the associated epoch time. As the epoch time is present, the ephemeris of the candidate cell in condEventD2 may be present, and the epoch time is also associated with condEventD2. If the ephemeris in condEventD2 is absent, the ephemeris in the SIB19 neighbor cell configuration is applied.

In some embodiments, the condEventD2 can be specified as follows. The CondEventD2 may be triggered when a distance between UE and a moving reference location of a serving cell is above threshold1 and a distance between UE and a moving reference location of a candidate is below threshold2. The UE may perform the following operations:
1> determine the reference location for variable Ml1 and Thresh1, as specified below, based on referenceLocation1 at the epoch Time in measObjectNR (or reportConfigNR) for this event and the serving cell's satellite ephemeris.
1> determine the reference location for variable Ml2 and Thresh2, as specified below, based on referenceLocation2 at the epochTime in measObjectNR (or reportConfigNR) for this event and the candidate's satellite ephemeris (e.g., the candidate's satellite ephemeris can be included in this event i.e., condEventD2, or in the measurement object configuration configured for this event, or in the SIB19 provided by neighbor cell configuration).
1> consider the entering condition for this event to be satisfied when both condition D2-1 and condition D2-2, as specified below, are fulfilled;
1> consider the leaving condition for this event to be satisfied when condition D2-3 or condition D2-4, i.e. at least one of the two, as specified below, are fulfilled;

### Inequality D2-1 (Entering Condition 1)

$$Ml 1 - Hys > Thresh 1 \qquad ( 10 )$$

### Inequality D2-2 (Entering Condition 2)

$$Ml 2 + Hys < Thresh 2 \qquad ( 11 )$$

### Inequality D2-3 (Leaving Condition 1)

$$Ml 1 + Hys < Thresh 1 \qquad ( 12 )$$

### Inequality D2-4 (Leaving Condition 2)

$$Ml 2 - Hys > Thresh 2 \qquad ( 13 )$$

The variables in the formula are defined as follows:
Ml1 is the distance between UE and a reference location for this event, not taking into account any offsets.
Ml2 is the distance between UE and a reference location for this event, not taking into account any offsets.
Hys is the hysteresis parameter for this event (i.e. hysteresisLocation as defined within reportConfigNR for this event).
Thresh1 is the threshold for this event defined as a distance, configured with parameter distance ThreshFromReference1, from a reference location.
Thresh2 is the threshold for this event defined as a distance, configured with parameter distance ThreshFromReference2, from a reference location.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

This disclosure presents various solutions for a location-dependent broadcast service in NTN which covers a larger area than a TN cell. These solutions offer significant improvements and distinctions. For instance, the location-dependent broadcast service in NTN ensures that only UEs within a specific geographic area receive the broadcast service, enhancing broadcast efficiency and conserving transmission resources. Additionally, by providing tailored broadcast information to UEs within specific locations within an NTN cell, the broadcast service ensures that the transmitted data is more relevant to the recipients. This targeted approach enhances the user experience by delivering only pertinent information.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to:
receive, from a base station (BS), broadcast service area information for a broadcast service via system information, the broadcast service area information indicating an intended service area of the broadcast service; and
a processor operably coupled to the transceiver, the processor configured to:
identify a location of the UE; and
receive, from the BS, the broadcast service based on the location of the UE and the intended service area.

2. The UE of claim 1, wherein:
the broadcast area information includes an area identifier for the intended service area; and
the processor is configured to receive the broadcast service based on the location of the UE and the area identifier for the intended service area.

3. The UE of claim 1, wherein the intended service area is a geographic area represented by a reference location and a radius, or by a polygon.

4. The UE of claim 1, wherein the processor is further configured to:
initiate a broadcast service radio bearer establishment procedure to receive the broadcast service based on a determination that the location of the UE is within the intended service area.

5. The UE of claim 1, wherein the intended service area is associated with a broadcast service session.

6. The UE of claim 1, wherein the processor is further configured to:
initiate a broadcast service radio bearer release procedure to stop receiving the broadcast service based on a determination that the UE leaves the intended service area.

7. The UE of claim 1, wherein the processor is further configured to:
prioritize, during cell reselection, a frequency that is associated with receiving the broadcast service.

8. The UE of claim 1, wherein the processor is further configured to:
deprioritize, during cell reselection, a frequency that is not associated with receiving the broadcast service.

9. A base station (BS) for facilitating communication in a wireless network, the BS comprising:
a processor configured to:
generate broadcast service area information for a broadcast service, the broadcast service area information indicating an intended service area of the broadcast service; and
a transceiver operably coupled to the processor, the transceiver configured to:
transmit, to a user equipment (UE), the generated broadcast service information,
wherein the processor is further configured to generate the broadcast service associated with the broadcast service area information,
wherein the transceiver is further configured to transmit, to the UE, the generated broadcast service.

10. The BS of claim 9, wherein the broadcast area information includes an area identifier for the intended service area.

11. The BS of claim 9, wherein the intended service area is a geographic area represented by a reference location and a radius, or by a polygon.

12. The BS of claim 9, wherein the intended service area is associated with a broadcast service session.

13. A method performed by a user equipment (UE) in a wireless network, the method comprising:
receiving, from a base station (BS), broadcast service area information for a broadcast service via system information, the broadcast service area information indicating an intended service area of the broadcast service;
identifying a location of the UE; and
receiving, from the BS, the broadcast service based on the location of the UE and the intended service area.

14. The method of claim 13, wherein:
the broadcast area information includes an area identifier for the intended service area; and
the broadcast service is received based on the location of the UE and the area identifier for the intended service area.

15. The method of claim 13, wherein the intended service area is a geographic area represented by a reference location and a radius, or by a polygon.

16. The method of claim 13, further comprising:
initiating a broadcast service radio bearer establishment procedure to receive the broadcast service based on a determination that the location of the UE is within the intended service area.

17. The method of claim 13, wherein the intended service area is associated with a broadcast service session.

18. The method of claim 13, further comprising:
initiating a broadcast service radio bearer release procedure to stop receiving the broadcast service based on a determination that the UE leaves the intended service area.

19. The method of claim 13, further comprising:
prioritizing, during cell reselection, a frequency that is associated with receiving the broadcast service.

20. The method of claim 13, further comprising:
deprioritize, during cell reselection, a frequency that is not associated with receiving the broadcast service.
